(19) United States
(12) Patent Application Publication
(10) Pub. No.: US 2021/0312105 A1
(43) Pub. Date: Oct. 7, 2021

(54) CONSTRUCTION MANAGEMENT DOCUMENT CREATION DEVICE, CONSTRUCTION MANAGEMENT DOCUMENT CREATION METHOD, PIPELINE CONSTRUCTION DRAWING CREATION DEVICE, AND PIPELINE CONSTRUCTION DRAWING CREATION METHOD

(71) Applicant: KUBOTA CORPORATION, Osaka (JP)

(72) Inventors: Shozo KISHI, Amagasaki-shi (JP); Yuito KOMARU, Amagasaki-shi (JP); Kazuma HARADA, Amagasaki-shi (JP); Akira YAMASHITA, Amagasaki-shi (JP)

(73) Assignee: KUBOTA CORPORATION, Osaka (JP)

(21) Appl. No.: 17/224,219

(22) Filed: Apr. 7, 2021

(30) Foreign Application Priority Data
Apr. 7, 2020 (JP) 2020-068780

(51) Int. Cl. G06F 30/18; G06F 30/13; G06F 30/20; G06Q 50/08

(52) U.S. Cl. CPC G06F 30/18; G06F 30/13; G06F 2111/04; G06Q 50/08; G06F 30/20

(57) ABSTRACT

A construction management document creation device includes: a first input processing unit configured to repeat a process of assigning a unique pipe number and a unique joint number in association with pipe attribute information, and thereby generate pipe connection information from which connection relationship between laying pipes is identifiable based on the pipe number and the joint number, and pipe laying information from which a type and a laying position of each laying pipe are identifiable based on the pipe attribute information; a second input processing unit configured to generate assembled condition management information based on assembling procedure confirmation information and assembled condition evaluation information input for each pipe assembling section identified by the joint number; and a document generation processing unit configured to generate a construction management document including a daily construction report based on the pipe connection information, the pipe laying information, and the assembled condition management information.

### CROSS-REFERENCE TO RELATED APPLICATIONS

The present application claims priority under 35 U.S.C. 119 to Japanese Patent Application No. 2020-068780 filed on Apr. 7, 2020, the contents of this application are incorporated by reference.

### BACKGROUND OF THE INVENTION

### Field of the Invention

The present disclosure relates to a construction management document creation device that creates construction management documents based on construction management information about pipes collected at a pipeline construction site, and to a construction management document creation method, a pipeline construction drawing creation device, and a pipeline construction drawing creation method.

### Description of the Related Art

A contractor working on a pipeline construction project, such as building a water supply pipe network, is required to fulfill associated duties including filling in a daily construction report with information about materials used for the pipeline construction and drawings identifying details of the work at the end of every day worked on the construction, and submitting, to a construction manager upon completion of the construction, an as-built drawing that shows buried positions of the pipes and an offset diagram that shows more accurate buried positions of the pipes than the as-built drawing.

However, creating such documents is a very complicated task for the contractor, so that the degree of accuracy of information recorded in these documents cannot be guaranteed. For example, the contractor often makes notes about various kinds of pipe materials used for the construction and buried positions of pipes in notebooks and later creates the above documents all at once with reference to the notes. However, this way of creating the documents often involves transcribing errors, and also lacks accuracy because it is often the case where positions of the pipes are measured after they have been actually buried.

Meanwhile, a need exists for a recording method that enables post-work inspection of whether pipe assembling sections (pipe joint sections) have been appropriately assembled.

In order to reduce the burden of the above complicated task, Japanese Unexamined Patent Application Publication No. 2015-075927 proposes an as-built pipeline drawing creation method including: uploading, from a transmission device to a construction management information server, pipe information, location information, and image information acquired respectively from a pipe information acquisition device configured to acquire pipe information based on photograph information about pipe information labels affixed to pipes disposed at a construction site, a GPS receiver configured to acquire location information about the construction site, and an image acquisition device configured to acquire images of joint sections of the pipes; and creating an as-built drawing on a map managed by a mapping processing unit provided to an information processing terminal, based on the pipe information, the location information, and the image information downloaded from the construction management information server to the information processing terminal.

The as-built pipeline drawing creation method ensures the collection of accurate information as the method allows the pipe information, the location information, and the image information to be collected at the construction site and uploaded to the construction management information server without requiring efforts from operators such as making notes about the pipe information in notebooks, measuring positions of the pipes with a measurement device, and photographing the pipes. The method thus enables appropriate verification of assembled conditions based on such accurate information, enables automatic generation of a daily construction report, and enables generation of an accurate as-built drawing on the information processing terminal at any location by connecting to the construction management information server.

Japanese Unexamined Patent Application Publication No. 2018-014011 discloses a pipeline construction drawing creation method and a pipeline construction drawing creation device that can automatically generate a pipeline construction drawing in a simplified manner without using a GPS location information system.

The pipeline construction drawing creation device includes: a pipe information acquisition unit configured to acquire, from a pipe information indication added to each laying pipe, pipe information from which a pipe shape is identifiable; a pipe laying information input unit configured to receive input of pipe laying information based on the pipe shape acquired from the pipe information, the pipe laying information including orientation of each laying pipe and/or the order of assembling pipe ends to be assembled; an assembled relationship information generation unit configured to generate assembled relationship information about each laying pipe using an information processing device; a pipeline construction drawing generation unit configured to generate a pipeline construction drawing using the information processing device based on the pipe shape, the pipe laying information, and the assembled relationship information, the pipeline construction drawing showing relative connection relationship between the laying pipes in plan view; and a pipeline construction drawing display unit configured to display the pipeline construction drawing generated by the pipeline construction drawing generation unit.

The pipeline construction drawing creation device is configured to acquire the pipe information through the pipe information acquisition unit, receive input of the pipe laying information, including orientation of each laying pipe and/or the order of assembling pipe ends to be assembled, through the pipe laying information input unit, and generate the assembled relationship information through the assembled relationship information generation unit, at least every time a pipe assembling process is completed at the construction site.

However, since the above conventional pipeline construction drawing creation device is configured to acquire the pipe information through the pipe information acquisition unit, receive input of the pipe laying information, including orientation of each laying pipe and/or the order of assembling the pipes to be assembled, through the pipe laying information input unit, and generate the assembled relationship information through the assembled relationship information generation unit every time a pipe assembling process is completed at the construction site, it is required that the pipes be laid in order from one end to the other end of a construction section.

This may limit the flexibility in the laying work and reduce construction efficiency. For example, the device is unable to generate appropriate assembled relationship information in such cases where pipes are laid from both ends of the construction section or where pipes are laid from one end to the other end of the construction section while skipping an intermediate section thereof for reasons such as presence of an obstacle. As such, the pipeline construction drawing creation device cannot be utilized with flexibility.

### SUMMARY OF THE INVENTION

In view of the above problems with the related art, it is an object of the present invention to provide a construction management document creation device, a construction management document creation method, a pipeline construction drawing creation device, and a pipeline construction drawing creation method each of which increases the flexibility in pipe laying work.

A first aspect of the present invention is a construction management document creation device for creating a construction management document based on construction management information about pipes collected at a pipeline construction site. The device includes: a first input processing unit configured to repeat a process of assigning a unique pipe number and a unique joint number in association with pipe attribute information, the pipe attribute information including a pipe shape and a pipe laying position that are input for each laying pipe adopted at the construction site based on pipeline design information, and configured to thereby generate pipe connection information from which connection relationship between laying pipes is identifiable based on the pipe number and the joint number, and pipe laying information from which a type and a laying position of each laying pipe are identifiable based on the pipe attribute information; a second input processing unit configured to generate assembled condition management information based on assembling procedure confirmation information and assembled condition evaluation information that are input for each pipe assembling section identified by the joint number; and a document generation processing unit configured to generate a construction management document based on the pipe connection information, the pipe laying information, and the assembled condition management information.

A second aspect of the present invention is a construction management document creation method executed by an information processing device configured to create a construction management document based on construction management information about pipes collected at a pipeline construction site. The method includes: a first input process of repeating a process of assigning a unique pipe number and a unique joint number in association with pipe attribute information, the pipe attribute information including a pipe shape and a pipe laying position that are input for each laying pipe adopted at the construction site based on pipeline design information, and thereby generating pipe connection information from which connection relationship between laying pipes is identifiable based on the pipe number and the joint number, and pipe laying information from which a type and a laying position of each laying pipe are identifiable based on the pipe attribute information; a second input process of generating assembled condition management information based on assembling procedure confirmation information and assembled condition evaluation information that are input for each pipe assembling section identified by the joint number; and a document generation process of generating a construction management document based on the pipe connection information, the pipe laying information, and the assembled condition management information, and storing the construction management document in a storage unit.

A third aspect of the present invention is a pipeline construction drawing creation device for creating a pipeline construction drawing based on construction management information about pipes collected at a pipeline construction site. The device includes: the construction management document creation device of the first aspect; a pipeline construction drawing generation unit configured to generate a pipeline construction drawing based on the pipe connection information, the pipe laying information, and the assembled condition management information, and store the pipeline construction drawing in a storage unit, the pipeline construction drawing representing relative connection relationship between laying pipes in plan view; and a pipeline construction drawing display processing unit configured to display the pipeline construction drawing generated by the pipeline construction drawing generation unit.

A fourth aspect of the present invention is a pipeline construction drawing creation method for creating a pipeline construction drawing based on construction management information about pipes collected at a pipeline construction site. The method includes: the construction management document creation method of the second aspect; a pipeline construction drawing generation process of generating a pipeline construction drawing based on the pipe connection information, the pipe laying information, and the assembled condition management information, and storing the pipeline construction drawing in a storage unit, the pipeline construction drawing representing relative connection relationship between laying pipes in plan view; and a pipeline construction drawing display process of displaying the pipeline construction drawing generated by the pipeline construction drawing generation process.

Additional aspects of the invention will be clarified with reference to embodiments given below.

### BRIEF DESCRIPTION OF THE DRAWINGS

Some embodiments of the present disclosure are shown by way of example, and not of limitation, in the accompanying figures.

FIG. 1 illustrates an operation for assembling pipes;

FIG. 2A illustrates a sectional structure of a joint section between the pipes;

FIG. 2B is a sectional view of a rubber gasket;

FIG. 2C illustrates a sectional structure of major parts of the joint section between the pipes with the rubber gasket attached appropriately.

FIG. 2D illustrates a sectional structure of the major parts of the joint section between the pipes with the rubber gasket attached inappropriately.

FIG. 3A illustrates a white line on the joint section.

FIG. 3B illustrates a deflection angle θ of the joint section.

FIG. 4 is a functional block diagram of a construction management document creation device.

FIG. 5 is a flowchart of a pipeline construction drawing creation method executed by an information processing terminal.

FIG. 6 is a flowchart of a pipeline construction drawing creation method executed by an information processing server.

FIG. 7 illustrates an input screen displayed on the information processing terminal.

FIG. 8 illustrates an input screen for pipe numbers and joint numbers displayed on the information processing terminal.

FIG. 9 illustrates a check screen for assembling sections.

FIG. 10 illustrates a check screen for assembling sections to receive input of a retraction distance of the rubber gasket.

FIG. 11 illustrates a check screen for assembling sections to receive input of a protrusion distance to the white line.

FIG. 12 illustrates a daily construction report.

FIG. 13 illustrates a pipeline construction drawing.

### DESCRIPTION OF THE PREFERRED EMBODIMENTS

Hereinafter, a description will be given of a construction management document creation device that creates construction management documents based on construction management information about pipes collected at a pipeline construction site, a construction management document creation method, a pipeline construction drawing creation device, and a pipeline construction drawing creation method, by taking a pipe assembly for water supply pipes using ductile cast iron pipes (hereinafter referred to as “DCIPs”) as an example.

[Description of Pipe Laying Work]

Pipe laying work includes excavation work of excavating the ground to form a trench, assembling work of laying pipes on the trench and assembling the pipes, and backfilling work of backfilling the trench after the assembly.

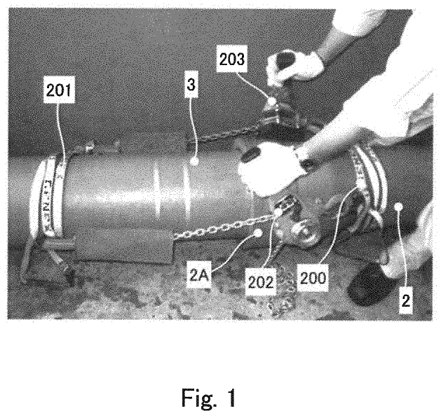

FIG. 1 illustrates an operation for assembling pipes having a so-called push-on type pipe joint structure. With a socket 2A of one pipe 2 receiving a spigot of another pipe 3, an assembling device 200 composed of a sling belt or a chain is wound around the socket pipe 2 at a position near the socket 2A, and a similar assembling device 201 is wound around the spigot pipe 3 at a position near the spigot. Then, the assembling devices 200, 201 are manually wound up with lever hoists 202, 203 disposed on both sides of the pipes 2, 3 between the assembling devices.

In cases of laying fittings other than pipes or cut pipes, a spigot of one pipe is inserted into a socket of another pipe, and then a gland and a flange of the socket are tightened together with T-head bolts and nuts such that a rubber gasket is inserted between the spigot and the socket with the aid of the gland. Fittings include bends with a bend degree of 90°, 45°, 22.5°, 11.25°, etc., offset pipes, and branch pipes such as triple socket cross pipes and double socket tees.

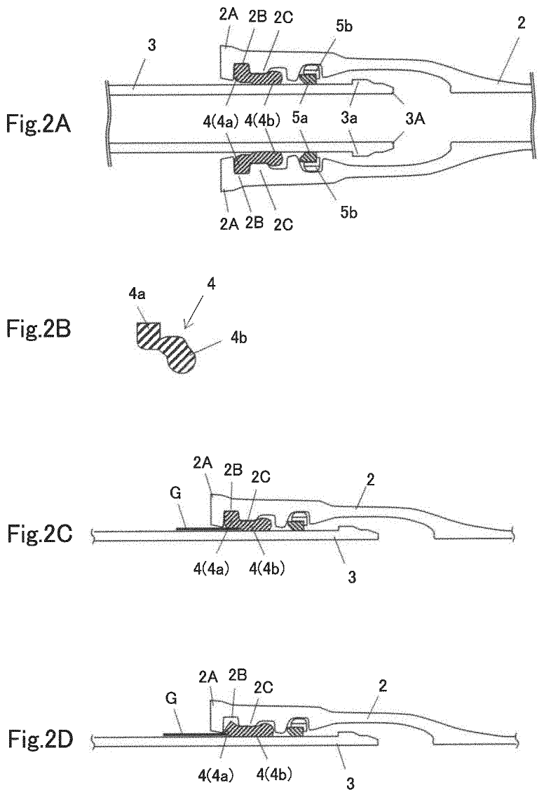

FIGS. 2A to 2D are sectional views of a joint section between the pipes 2, 3 assembled by the above assembling operation. The spigot 3A formed at the end of the other pipe 3 is inserted inside the socket 2A formed at the end of the one pipe 2. A sealing rubber gasket 4 is interposed and compressed between the inner circumferential surface of the socket 2A and the outer circumferential surface of the spigot 3A, and a lock ring 5a engages a bead 3a formed on the spigot 3A to prevent disengagement of the pipes. In FIG. 2A, reference numeral 5b denotes a lock ring positioning member.

As shown in FIG. 2B, the rubber gasket 4 includes a heel portion 4a and a bulb portion 4b. With the pipes 2, 3 assembled appropriately, the rubber gasket 4 has its heel portion 4a fitted to a rubber gasket accommodating recess 2B formed on the inner circumferential surface of the socket 2A and has its bulb portion 4b compressed between a rubber gasket compressing protrusion 2C, which is continuous from the rubber gasket accommodating recess 2B, and the outer circumferential surface of the spigot pipe 3.

FIG. 2C illustrates a condition where the pipes 2, 3 are assembled with the rubber gasket 4 in an appropriate position. FIG. 2D illustrates a condition where the pipes 2, 3 are assembled with the rubber gasket 4 in an inappropriate position, so that the bulb portion 4b is pulled by the pipe 3 further into the pipe 2 and the heel portion 4a is disengaged from the rubber gasket accommodating recess 2B. Such an inappropriate pipe assembled condition as shown in FIG. 2D impairs the sealing function of the rubber gasket 4, and thus the assembling operation needs to be redone.

Hence, upon completion of the assembling operation, an operator confirms whether the rubber gasket 4 is in an appropriate position by inserting a feeler gauge G between the pipes 2, 3 and measuring a retraction distance up to the position of the rubber gasket 4, i.e., a distance from the pipe end face of the socket 2A to a position at which the feeler gauge G contacts the rubber gasket 4, at eight locations equally spaced in the circumferential direction (every 45° central angle) of the pipe.

The feeler gauge G is typically a plate body with a predetermined thickness and having on its face a scale to measure the retraction distance. Alternatively, use may be made of an electronic feeler gauge that measures an insertion depth of the feeler gauge G from the pipe end face as the retraction distance and wirelessly transmits the measurement result to the outside via a near field communication interface.

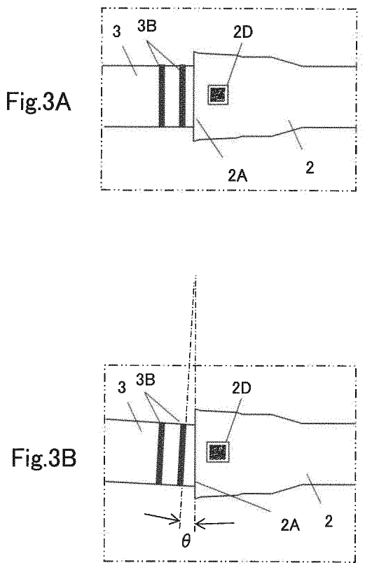

FIGS. 3A and 3B illustrate a white line 3B painted around the circumferential surface of the spigot pipe 3 near the assembling section of the socket 2A and the spigot 3A. FIG. 3A illustrates a condition where the pipes 2, 3 are substantially linearly assembled. FIG. 3B illustrates a condition where the pipes 2, 3 are assembled while being slightly deflected. A deflection angle θ of the assembling section can be obtained by measuring a protrusion distance from the linear pipe end of the socket pipe 2 to the white line 3B at four locations equally spaced along the circumferential direction of the pipes. In FIGS. 3A and 3B, reference numeral 2D denotes a two-dimensional bar code representing pipe information.

A maximum allowable deflection angle θ is 4° in the case of the push-on type pipe joint structure. Hence, when the pipes are laid linearly, the allowable deflection angle θ is set within a small range near 0° to keep the pipes linear. When the pipes are laid in an arc shape with a small curvature along a road, the allowable deflection angle θ is set within a predetermined range from 0° to 4° such that a plurality of pipes are laid to form the arc shape as a whole.

[Configuration of the Construction Management Document Creation Device and the Pipeline Construction Drawing Creation Device]

A contractor operating at a pipeline construction site is required to record, in each daily construction report, pipeline construction information for creating as-built drawings and other documents after completion of the project. The construction management document creation device according to the present invention enables automatic generation of daily construction reports recording information such as a construction name, a construction date, and types, nominal diameters and lengths of pipes laid, based on construction management information about pipes collected at the pipeline construction site. The pipeline construction drawing creation device has, in addition to the functions of the construction management document creation device, a function of automatically generating simple pipeline construction drawings in which types, nominal diameters and lengths of pipes laid as well as assembled relationship between the pipes can be identified, based on the construction management information about pipes collected at the pipeline construction site.

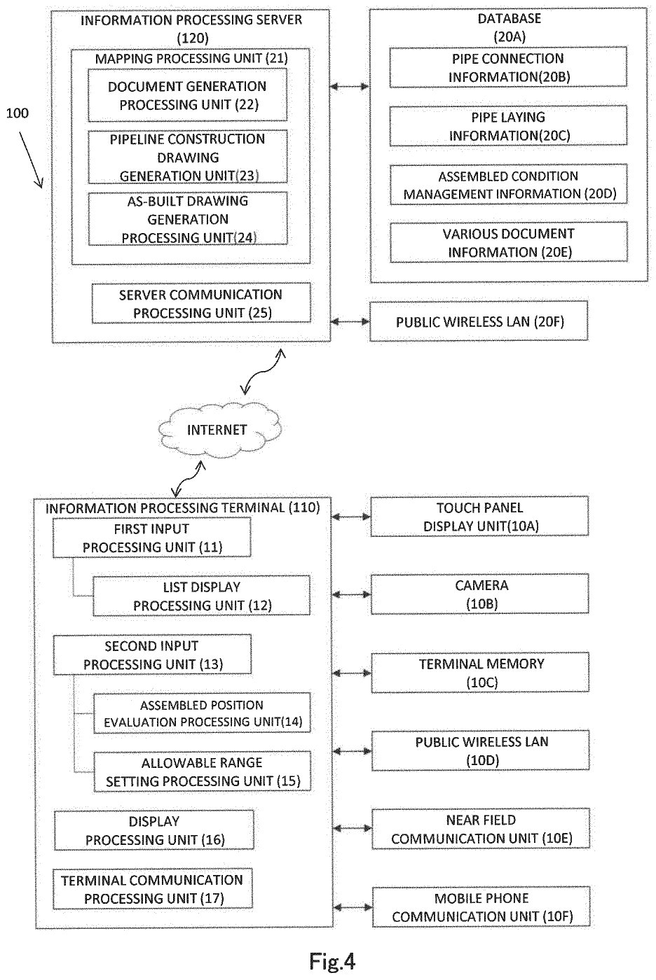

As shown in FIG. 4, the construction management document creation device 100 includes an information processing terminal 110 that is used at the construction site and an information processing device (information processing server) 120 that can communicate with the information processing terminal 110 and is installed at a remote location from the construction site. Connected to the information processing server 120 is a database 20A that stores construction management information including pipe connection information 20B, pipe laying information 20C, and assembled condition management information 20D, and various document information 20E including daily construction reports, pipeline construction drawings, and as-built drawings each generated based on the construction management information.

For mutual communication via communication media such as the Internet, the information processing terminal 110 and the information processing server 120 include communication devices (interfaces) such as public wireless LANs 10D, 20F, which is e.g. Wi-Fi®, and a mobile phone communication unit 10F, as well as communication processing units 17, 25 controlling these communication devices.

The information processing terminal 110 may be a mobile computer such as a laptop computer, a tablet computer, or a smartphone. The information processing terminal 110 as a mobile computer or the like includes a CPU board, a touch panel display unit 10A, a camera 10B, a terminal memory 10C, the public wireless LAN 10D, a near filed communication unit 10E, the mobile phone communication unit 10F, and the like. For example, the information processing terminal 110 is capable of outputting daily construction reports, pipeline construction drawings, as-built drawings and other documents to an external printer via the near filed communication unit 10E.

The CPU board is mounted with a CPU and a non-volatile memory. Application software for supporting pipeline construction is installed in the non-volatile memory. The application software is executed by the CPU. Alternatively, in the case of the above information processing server 120 being a cloud server, the application software for supporting pipeline construction prepared in the cloud server 120 is executed via the CPU of the information processing terminal 110. Execution of the application software implements various functional blocks discussed later, including a first input processing unit 11, a list display processing unit 12, a second input processing unit 13, an assembled position evaluation processing unit 14, an allowable range setting processing unit 15, a display processing unit 16, and a communication processing unit 17.

The information processing server 120, to which a plurality of information processing terminals 110 used at each construction site are connected via the respective communication processing units 17, 25, is mounted with a motherboard and a memory board. Application software for managing and supporting pipeline construction is installed in a memory on the memory board, and executing the application software by a CPU on the motherboard implements functions of a mapping processing unit 21 capable of automatically generating pipeline drawings.

As will be described later, the mapping processing unit 21 is provided with functional blocks including a document generation processing unit 22 to automatically generate daily construction reports based on construction management information transmitted from the information processing terminal 110, a pipeline construction drawing generation unit 23 to automatically generate pipeline construction drawings, and an as-built drawing generation processing unit 24 to automatically generate as-built drawings based on detailed construction management information.

The pipeline construction drawing creation device is configured by adding the functional blocks of the pipeline construction drawing generation unit 23 and the as-built drawing generation processing unit 24 to the construction management document creation device 100. Hereinafter, the construction management document creation device 100 will be described in detail.

[Pipeline Construction Management at the Construction Site]

The first input processing unit 11 provided to the information processing terminal 110 repeats a process of assigning a unique pipe number and a unique joint number in association with pipe attribute information including a pipe shape and a pipe laying position that are input for each laying pipe adopted at the construction site based on pipeline design information prepared in advance, and thereby generates pipe connection information from which connection relationship between the laying pipes is identifiable based on the pipe number and the joint number and generates pipe laying information from which the type and laying position of each laying pipe is identifiable based on the pipe attribute information. The pipeline design information may be stored in the information processing terminal 110 as electronic data to be displayed on the display unit 10A, or may be in the form of paper drawings that can be visually checked by operators.

The first input processing unit 11 includes the list display processing unit 12 to display a list of a plurality of available options for pipe attribute information. By the operator selecting applicable ones from the available options for the pipe attribute information displayed by the list display processing unit 12 on the screen, desired pipe attribute information can be input.

The list display processing unit 12 is configured to hierarchically display the pipe attribute information. First, the list display processing unit 12 displays a first selection screen that presents eleven options for the pipe shape, namely “pipe”/“cut pipe with socket and spigot, cut pipe with double spigot, P-link”/“90° bend”, “45° bend”, “22½° bend”, “11¼° bend”, “5⅝° bend”/“double socket tee, tee with flanged branch, tee with flanged branch for shallow depth”/“collar, double socket short pipe, double socket bend, soft-seal valve”/“existing pipes”/“other fittings (e.g. reducer)”. It should be noted that these options are exemplary in nature, and actual options are set as appropriate according to changes in the lineup of pipes.

In response to the operator tapping and selecting an applicable pipe shape from the pipe shape options displayed on the first selection screen, the list display processing unit 12 is configured to display a second selection screen presenting further detailed options. By the operator tapping and selecting an applicable option from the options displayed on the second selection screen, setting of the pipe attribute information is completed. It should be noted that the hierarchical structure is not limited to the two level structure.

For example, when the operator selects “90° bend” on the first selection screen, the second display screen appears presenting options for specifying the laying position. More specifically, the second display screen presents laying position options for specifying one of eight bending directions, namely “90° bend (HB) horizontal bend (left)”/“90° bend (HB) horizontal bend (right)”/“90° bend (CB) combination bend (upper left)”/“90° bend (CB) combination bend (lower left)”/“90° bend (CB) combination bend (upper right)”/“90° bend (CB) combination bend (lower right)”/“90° bend (VB) vertical bend (up)”/“90° bend (VB) vertical bend (down)”.

For example, when the operator selects “double socket tee” on the first selection screen, the second display screen appears presenting options for pipe orientations and the order of assembling pipe ends. The second display screen presents options as to whether a branch portion of the pipe is situated on the left side or on the right side thereof along the pipe laying direction.

The second input processing unit 13 includes the assembled position evaluation processing unit 14 and the allowable range setting processing unit 15. The assembled position evaluation processing unit 14 generates assembled condition management information based on assembling procedure confirmation information and assembled condition evaluation information that are input for each pipe assembling section identified by the joint number.

The assembling procedure confirmation information is information for confirming whether required items have been confirmed during an assembling operation, such as confirming presence or absence of the spigot bead, cleaning, and removing foreign matters. The assembled condition evaluation information includes the retraction distances from the socket end of the pipe to the position of the sealing rubber gasket fitted inside the assembling section measured at the plurality of locations along the circumferential direction of the pipe (in the present embodiment, eight locations at intervals of 45° central angles) with the above feeler gauge G, and the protrusion distances from the socket end of the pipe to the line marked around the spigot pipe measured with a gauge.

The assembled position evaluation processing unit 14 evaluates whether the rubber gasket is positioned appropriately based on the above retraction distances and displays the evaluation result. The assembled position evaluation processing unit 14 also evaluates whether the pipe deflection angle θ is appropriate based on the above protrusion distances and displays the evaluation result. The assembled position evaluation processing unit 14 stores these evaluation results in the terminal memory 10C as the assembled condition management information.

The allowable range setting processing unit 15 sets the allowable range of the pipe deflection angle θ calculated based on the above protrusion distances. The allowable range is a value managed for each joint number described above. The allowable range is initially set based on the pipeline design information at the time of inputting the joint number; for example, when the pipes are to be laid linearly, the allowable range is set within ±θ₀, and when the pipes are to be laid with a predetermined curvature, a deflection angle range of θ₁≤θ≤θ₂ is set along with setting a deflection section flag indicative of the curvature section.

With respect to joint numbers to which a deflection section flag is set, the allowable range setting processing unit 15 dynamically changes an allowable range of the deflection angle for pipes at assembling sections that have not yet been input, based on a cumulative value of deflection angles of pipes at a plurality of assembling sections that have already been input. While the allowable range setting processing unit 15 presets an allowable range of the deflection angle for each joint section to conform to the curvature, a cumulative error of deflection angles of a plurality of joint sections that have been assembled may become large. In such cases, in order to compensate for the cumulative error by changing an allowable range of the deflection angle for joint sections that have not yet been assembled, the allowable range setting processing unit 15 dynamically changes the allowable range of the deflection angle for pipes including assembling sections of corresponding joint numbers.

The document generation processing unit 22 is configured to generate construction management documents including a daily construction report based on the construction management information, which includes the pipe connection information, the pipe laying information, and the assembled condition management information. The document generation processing unit 22 is further configured to store the thus-generated construction management documents in the database 20A and transmit them to the information processing terminal 110. This allows the operator at the construction site to confirm, via the information processing terminal 110, the daily construction report and other documents that have been generated based on the construction management information set at the construction site via the information processing terminal 110.

The first input processing unit 11 has been described as having the list display processing unit 12 for setting of the pipe attribute information. Alternatively, the first input processing unit 11 may include any one of; a code information reading processing unit to read code information prepared in association with each laying pipe and identify the pipe attribute information therefrom; an image recognition processing unit to identify the pipe attribute information from a corresponding photograph of each laying pipe; and a design information acquisition processing unit to acquire the pipe attribute information based on code information added to the pipeline design information.

The code information reading processing unit may be implemented by the camera 10B and a code information reading application program. For example, a two-dimensional information label, such as QR Code®, affixed to the surface of the socket pipe as shown in FIGS. 3A and 3B may be associated with the pipe attribute information, and the camera 10B can be used as a code reader. Based on the two-dimensional information label read by the camera 10B, for example, the pipe attribute information stored in the database 20A connected to the information processing server 120 may be downloaded. For example, detailed information including a manufacturing date, a manufacturing plant, a model, a pipe type, a nominal diameter, and a serial number of the pipe can be acquired.

The image recognition processing unit may be implemented by the camera 10B and an image recognition application program. For example, the camera 10B may photograph a laying pipe that has been selected, the pipe shape of the photographed pipe may be identified through image processing, and the pipe attribute information corresponding to the identified pipe shape may be acquired.

For example, an AI or a machine learning algorithm may be utilized as such an image recognition processing algorithm. Examples include a neural network configured to receive an input of image elements extracting feature portions of the photographed laying pipe to its input layer and output the pipe attribute information from its output layer. In this case, the pipe attribute information may either be prestored in the terminal memory 10C of the information processing terminal 110 or be prestored in the database 20A connected to the information processing server 120. In either case, it is preferable to use the list display processing unit as well in order to identify the laying position.

The design information acquisition processing unit may be implemented by the camera 10B or the touch panel display unit 10A and an information acquisition application program. As the code information added to the pipeline design information is read by the camera 10B or entered via the touch panel display unit 10A, a pipe information list included in the pipeline design information identified by the code information may be read from the database 20A connected to the information processing server 120 and displayed on the touch panel display unit 10A for example, such that relevant pipe attribute information can be selected from the list displayed. In this case, the pipe laying position can also be identified from the pipeline design information.

[Description of the Construction Management Document Creation Method and the Pipeline Construction Drawing Creation Method]

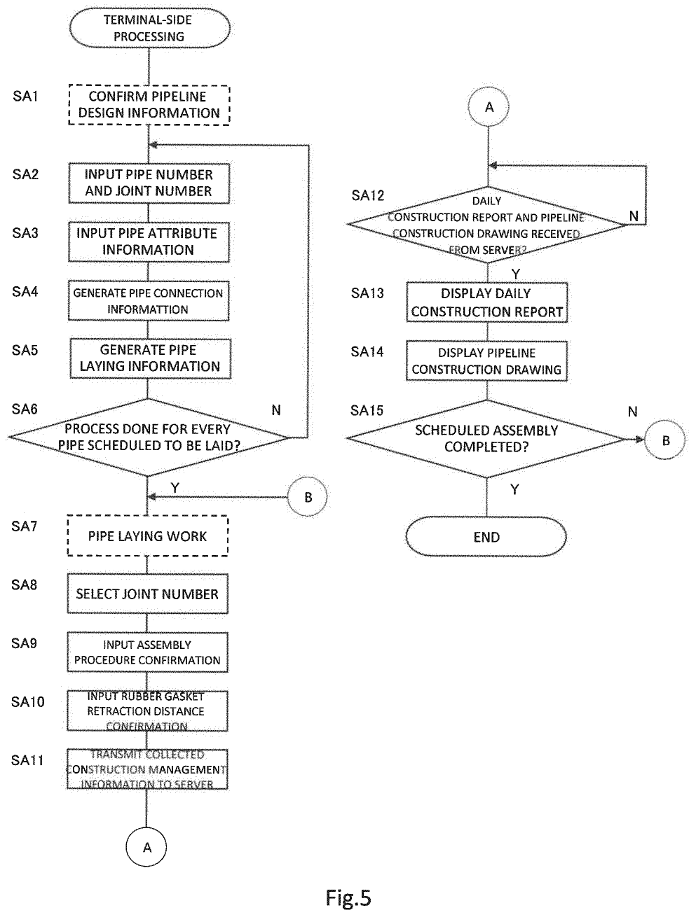

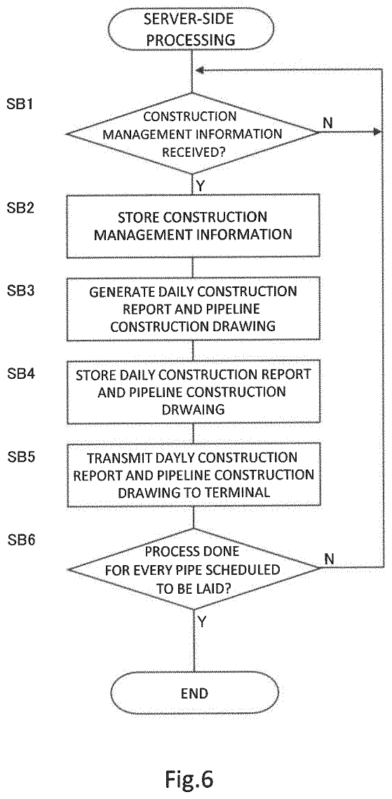

FIG. 5 illustrates a procedure of the construction management document creation method executed at the construction site using the information processing terminal 110 of the construction management document creation device described above. FIG. 6 illustrates a procedure of the construction management document creation method executed by the information processing server 120 of the construction management document creation device described above. Among steps enclosed in respective rectangles, those enclosed in dashed rectangles are executed by humans; the dashed rectangles are used to clarify that the steps therein are not executed by the construction management document creation device.

As shown in FIG. 5, at the construction site, an operator confirms the pipeline design information and enters management information, such as the kind of document, a construction date, and a construction name, into a management sheet input screen (SA1). Then, a pipe number and a joint number are input via the first input processing unit 11 of the information processing terminal 110 (SA2), and pipe attribute information about the laying pipe corresponding to the pipe number that has been input, namely the type (shape) and laying position of the pipe, is input (SA3).

The first input processing unit 11 generates the pipe connection information from which connection relationship between laying pipes can be identified based on input pipe numbers and joint numbers, and the pipe laying information from which the type and laying position of each laying pipe can be identified (SA4, SA5). It should be noted that the order of input of the pipe and joint numbers and input of the pipe laying information may be interchanged; the pipe laying information may be input first and then the pipe and joint numbers may be set for each corresponding pipe.

The process of steps SA2 to SA5 is repeated for every laying pipe scheduled to be laid on the construction date regardless of progress of the construction, namely prior to actual execution of the pipe laying work (SA6, N). Once steps SA2 to SA5 have been executed for every laying pipe, this process completes (SA6, Y).

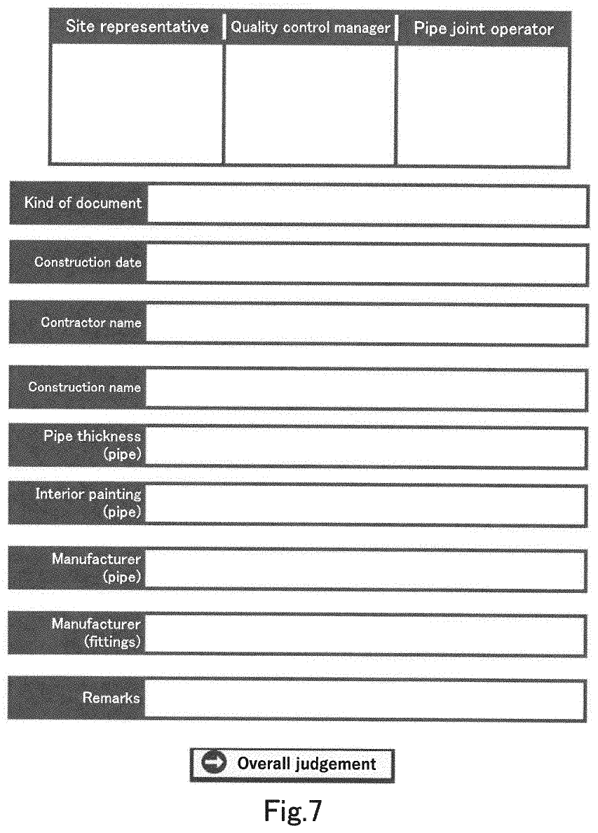

FIG. 7 illustrates a management sheet input screen. The list display processing unit 12 is configured to be capable of displaying a list of options in a pull-down menu in response to the operator tapping each field, allowing the operator to select appropriate one from the options.

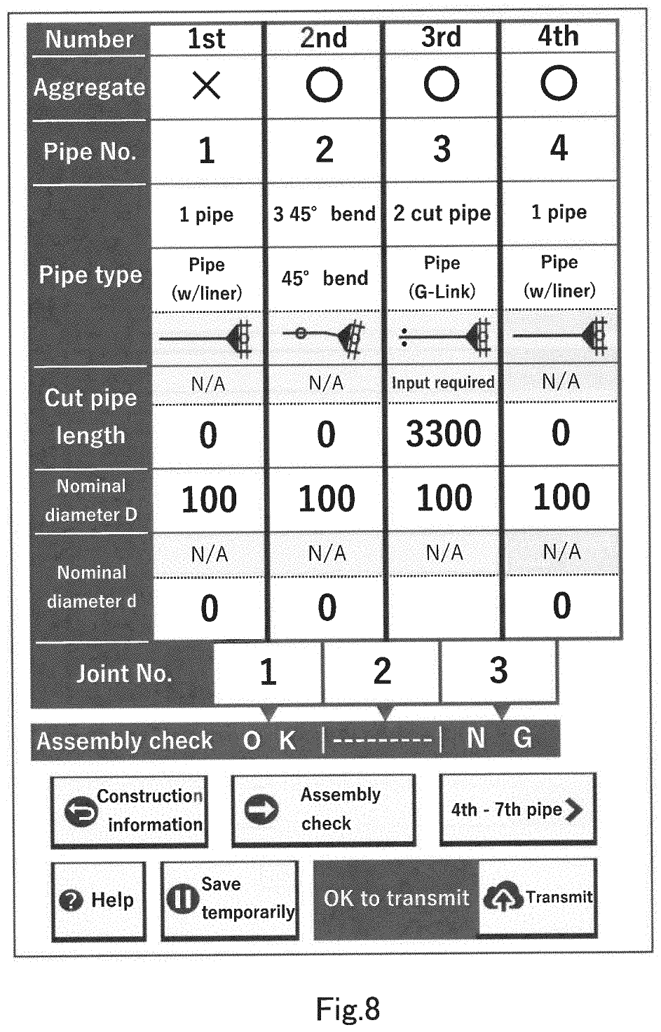

FIG. 8 illustrates one of input screens displayed by the input processing unit 11. The screen is for assigning information, including the pipe numbers and the joint numbers, to pipes used for the construction. The screen allows for input of the information for the first to ninth pipes. It should be noted that the first pipe is the last pipe that was laid in previous construction. The joint number is set for each pipe on the socket side. While the pipe numbers and the joint numbers do not have to be serial numbers, they need to be uniquely identifiable numbers. The pipe numbers and the joint numbers may be assigned automatically.

The input operation proceeds as the operator selects appropriate options from those displayed upon the operator tapping each field. For example, a cross mark “X”, which means “not applicable”, is assigned to the first pipe as it was laid in the other day, and a circle “O”, which means “applicable”, is assigned to the second pipe as it is to be used for the construction on the current day. Tapping “Pipe No.” field results in the pipe number being assigned automatically as a serial number and also results in the corresponding joint number being assigned automatically as a serial number.

In FIG. 8, joint number 1 is assigned to an assembling section between the pipes of pipe numbers 1 and 2, joint number 2 is assigned to an assembling section between the pipes of pipe numbers 2 and 3, and joint number 3 is assigned to an assembling section between the pipes of pipe numbers 3 and 4. Thus, the order of connecting the pipes can be identified.

In the case of inputting the type of the pipe of pipe number 2, a list of options for the pipe shape is displayed in a pull-down menu in response to the operator tapping an upper section of the “Pipe type” field. In this example, “45° bend” is selected. Further, a list of options for the laying position is displayed in a pull-down menu in response to the operator tapping a lower section of the “Pipe type” field. In this example, a right curved position is selected, and a symbol representing that position is displayed.

In response to the operator selecting a cut pipe as the pipe of pipe number 3, a text “Input required” is displayed in the field of “Cut pipe length”. The length is entered by the operator tapping a numeric keypad screen displayed on the display screen. In cases where a single pipe has bores of different values, as in the shape of a reducer and a double socket tee, a larger diameter is input in the “Nominal diameter D” field while a smaller diameter is input in the “Nominal diameter d” field.

Returning to FIG. 5, once the process of steps SA2 to SA5 has been thus done for every pipe to be laid on the construction date, actual pipe assembling work proceeds. After the operator finishes an assembling process of certain pipes (SA7), the “Joint No.” field relevant to the pipes that have been assembled is tapped and selected (SA8), which causes the display to switch to an assembly check screen.

Inputs confirming the assembly procedure are made on the assembly check screen (SA9), and the button “Next page” is tapped, which causes the display to switch to the next screen, namely an input screen for the assembled condition evaluation information such as retraction distances of the rubber gasket. Information such as the retraction distances is input on the input screen, and it is confirmed whether there is no problem with the information input (SA10). Then, the display returns to the screen of FIG. 8, and the pipe connection information including the pipe numbers and joint numbers, the pipe laying information including the pipe attribute information, and the assembled condition management information including the assembling procedure confirmation information and the assembled condition evaluation information are transmitted to the information processing server 120 (SA11).

A daily construction report and a pipeline construction drawing up to the point of completion of the work are transmitted from the information processing server 120 and displayed on the touch panel display unit 10A for confirmation by the operator (SA12, SA13, SA14). The process of steps SA7 to SA14 is executed every time an assembling process for each assembling section is completed (SA15).

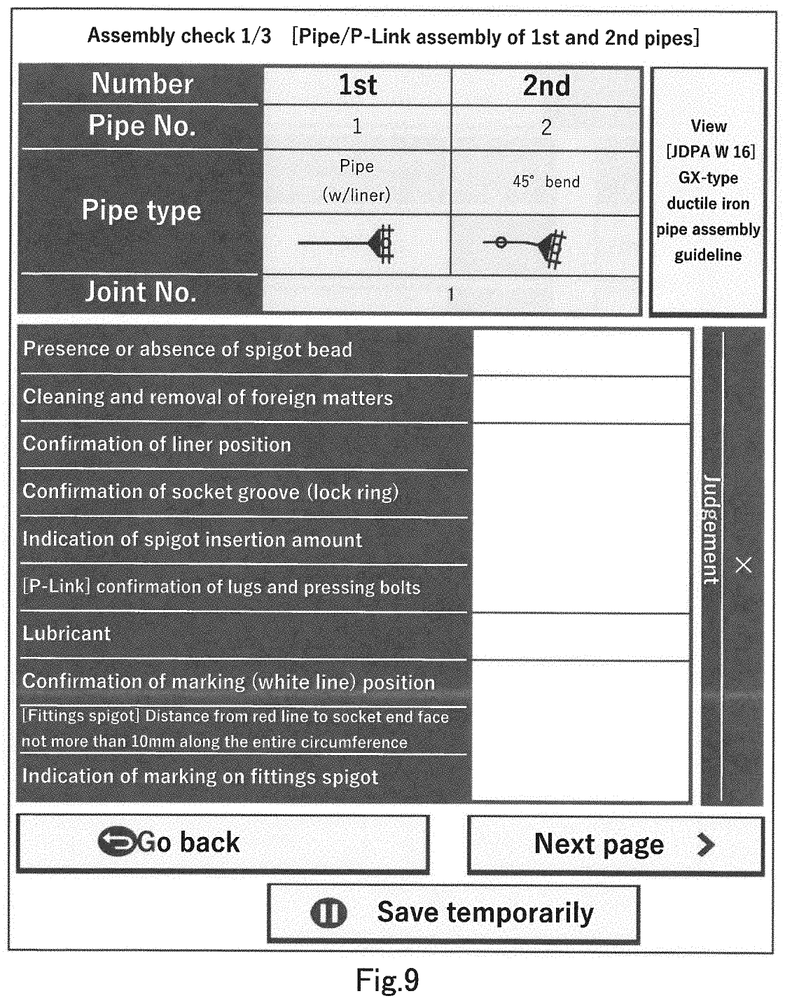

When the joint number relevant to the assembling process that has been finished is tapped and the “Assembly check” button in FIG. 8 is tapped, a first assembly check screen shown in FIG. 9 is displayed. When a checkbox to the right of each confirmation item such as the presence or absence of the socket bead, cleaning and removal of foreign matters, and confirmation of the liner position is tapped, the screen displays options of a circle “O”, which means “good”, and a cross mark “X”, which means “not good”. This enables verification of whether the work procedure is appropriate or not as the circle “O” is selected when the work has been done properly. It should be noted that a supervisor of the construction site is responsible for inputting this information, so that any illegitimate input by operators is prevented.

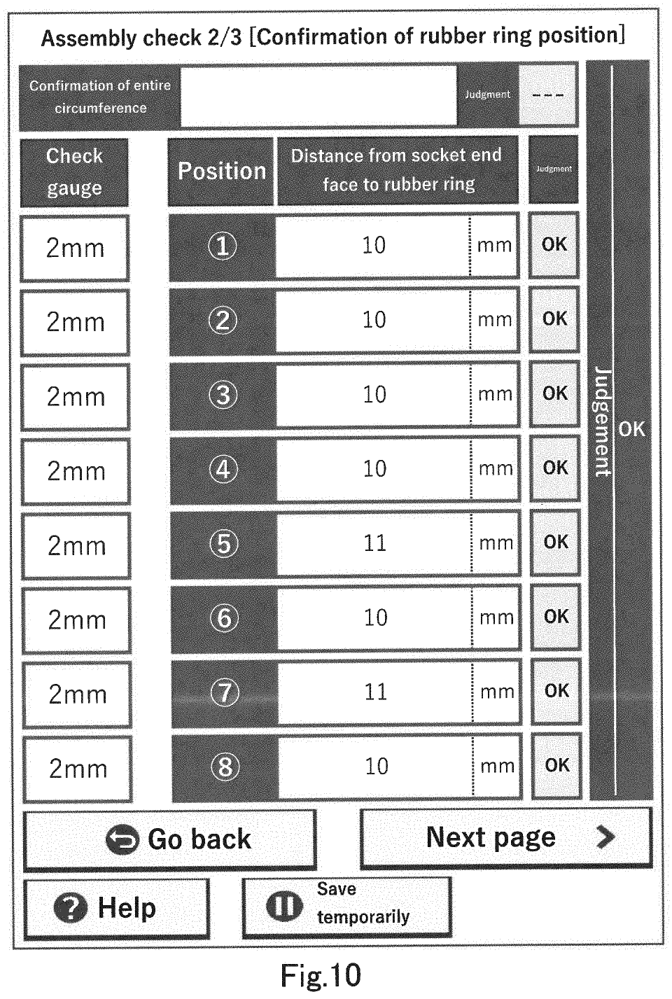

In response to the “Next page” button being tapped, the screen of FIG. 10 appears, allowing for input of values of the feeler gauge G inserted from the socket pipe end face (eight locations in the circumferential direction). When the input value is within an allowable range set in advance, the “OK” judgment is displayed. When the input value is out of the allowable range set in advance, the “NG” judgment is displayed. This enables easy determination of whether the rubber gasket is positioned appropriately or not. In the case of using an electronic feeler gauge, measurement data is wirelessly input via the near filed communication unit 10E. The near filed communication unit 10E may employ ZigBee® transmission, Bluetooth® transmission, or the like.

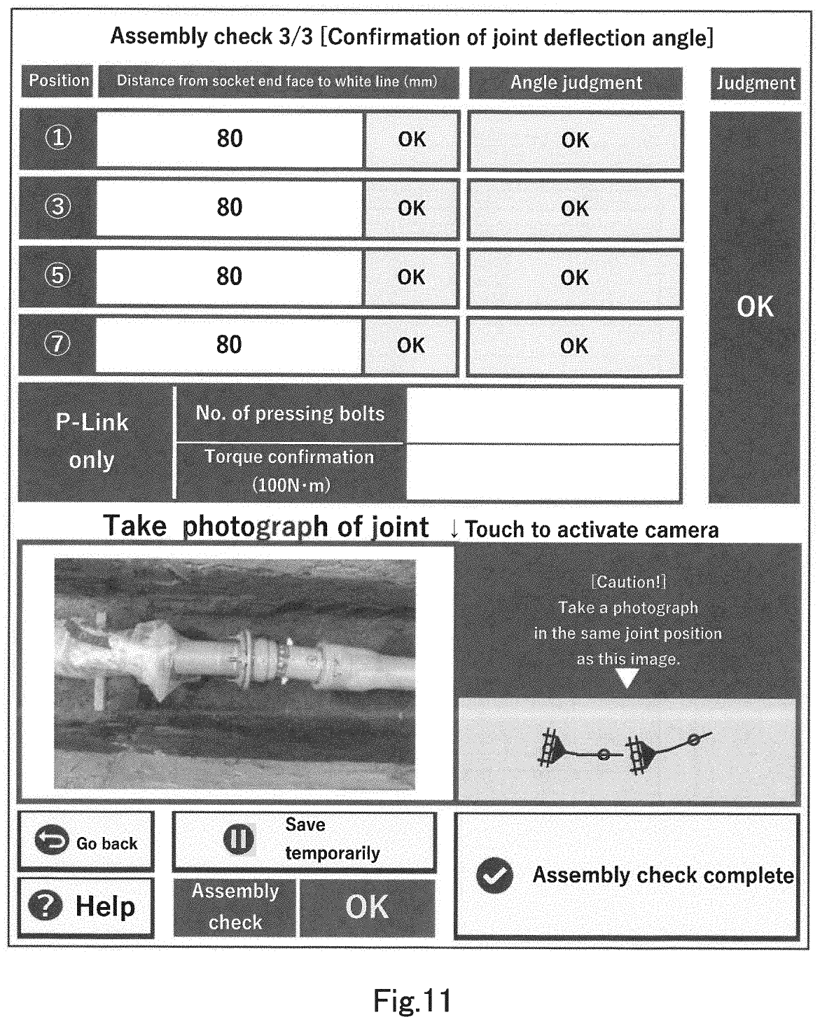

In response to the “Next page” button being tapped further, the screen of FIG. 11 appears, allowing for input of protrusion distances from the socket pipe end to the white line as measured with a scale (four locations in the circumferential direction). Thus, deflection angles θ of the joint sections are calculated, and it is automatically determined whether the angles are within an allowable range set in advance. In FIG. 11, the allowable range is prescribed for each of a value that is the difference between the value of position 1 and the value of position 3 and a value that is the difference between the value of position 5 and the value of position 7. If the judgment turns out to be “NG”, the operator adjusts the position of the spigot pipe and remeasures the protrusion distances until the “OK” judgment is presented.

After the “OK” judgment is thus presented, tapping the “Take photograph of joint” field activates the camera 10B, by which the joint section is photographed in the position corresponding to that shown in the right field. The image thus captured is pasted in the “Take photograph of joint” field. The image captured by the camera 10B is associated with latitude and longitude coordinate positions acquired by a position detection function of the information processing terminal.

Upon confirming that all items are given the “OK” judgment, tapping the “Assembly check complete” button causes the display to return to the screen of FIG. 8. Upon confirming that a text “OK to transmit” is displayed in the field to the left of the “Transmit” button in the screen of FIG. 8, tapping the “Transmit” button causes the pipe connection information including the pipe numbers and joint numbers, the pipe laying information including the pipe attribute information, and the assembled condition management information including the assembling procedure confirmation information and the assembled condition evaluation information to be transmitted to the information processing server 120. The assembled condition evaluation information includes the photograph of the joint and its coordinates described above. If any of the items is given the “NG” judgment, a text “NG to transmit” is displayed in the field to the left of the “Transmit” button, allowing the operator to determine whether the “Transmit” button can be tapped or not.

As shown in FIG. 6, upon receipt of the construction management information (the pipe connection information including the pipe numbers and joint numbers, the pipe laying information including the pipe attribute information, and the assembled condition management information including the assembling procedure confirmation information and the assembled condition evaluation information) from the information processing terminal 110 (SB1), the information processing server 120 stores the corresponding construction management information in the database 20A (SB2). The information processing server 120 then activates the document generation processing unit 22 and the pipeline construction drawing generation unit 23 of the mapping processing unit 21 to generate a daily construction report and a pipeline construction drawing (SB3). The information processing server 120 stores the daily construction report and the pipeline construction drawing in the database 20A (SB4) and also transmits them to the information processing terminal (SB5). The process of steps SB1 to SB5 is repeated until the construction for the current day ends (SB6).

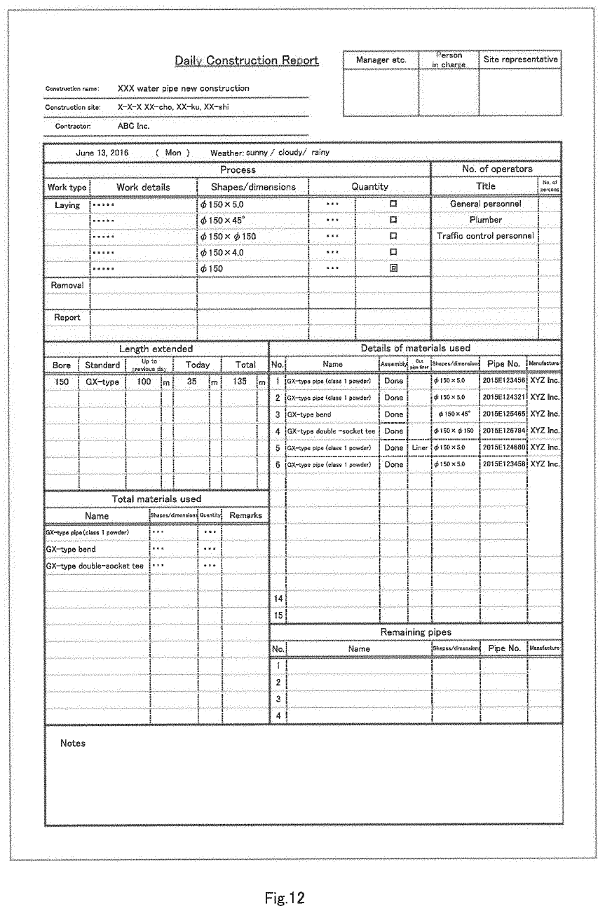

FIG. 12 illustrates a sample of the daily construction report. The daily construction report is a document that contains identification name fields including a construction name, a construction site, and a contractor, and item fields including a date of construction, weather, process, length extended, total materials used, details of materials used, and remaining pipes. The construction management information including the pipe information is filled in respective item fields.

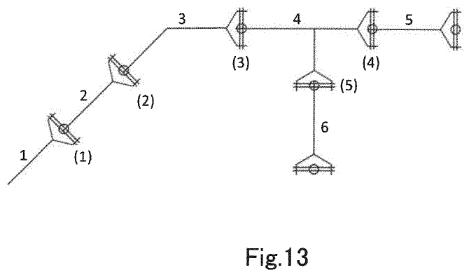

FIG. 13 illustrates a sample of the pipeline construction drawing. Each number in parentheses is a joint number, and each number without parentheses is a pipe number. It should be noted that the daily construction report and the pipeline construction drawing shown in FIGS. 12 and 13 do not correspond to the laying pipes discussed in FIG. 8, but are merely given as samples.

The position information about each assembling section can be identified from the position information added to each photograph of assembled pipes. The pipeline construction drawing generation unit 23 places an assembling section of the first pipe at any position on the drawing layer. Every time the pipeline construction information is transmitted from the information processing terminal 110, the pipeline construction drawing generation unit 23 repeats a process of drawing a line corresponding to the length of each pipe in plan view starting from the assembling section placed, based on the shape and length of each pipe obtained from the pipe information and based on the laying information about each pipe obtained from the pipe laying information, namely information about in which direction each pipe is curved or branched. The pipeline construction drawing generation unit 23 draws the lines while collating them with position information about subsequent assembling sections. This pipeline construction drawing shows how the pipes are laid and enables identification of relative assembled relationship between the pipes.

Without reference to the position information, the pipeline construction drawing generation unit 23 may also create the pipeline construction drawing by repeating a process of drawing a line corresponding to the length of each pipe in plan view starting from any assembling section, based on the shape and length of each pipe obtained from the pipe information and based on the laying information about each pipe obtained from the pipe laying information, namely information about in which direction each pipe is curved or branched.

At the construction site, the position information about each assembling section, e.g., information about how far the assembling section is located from a reference building, is determined by survey. The as-built drawing generation processing unit 24 can incorporate such information to finalize the pipeline construction drawing into an as-built drawing.

Alternatively, with reference to the position information about each assembling section, the as-built drawing generation processing unit 24 may draw an as-built drawing such that it is aligned with a road map managed by a mapping system.

The embodiment described above is merely an example and not intended to limit the scope of the present invention. Specific configurations of each unit, steps of each process, and other particulars may be modified as appropriate to the extent that such modifications ensure the advantageous effects of the present invention.

What is claimed is:

1. A construction management document creation device for creating a construction management document based on construction management information about pipes collected at a pipeline construction site, the device comprising:
a first input processing unit configured to repeat a process of assigning a unique pipe number and a unique joint number in association with pipe attribute information, the pipe attribute information including a pipe shape and a pipe laying position that are input for each laying pipe adopted at the construction site based on pipeline design information, and configured to thereby generate pipe connection information from which connection relationship between laying pipes is identifiable based on the pipe number and the joint number, and pipe laying information from which a type and a laying position of each laying pipe are identifiable based on the pipe attribute information;
a second input processing unit configured to generate assembled condition management information based on assembling procedure confirmation information and assembled condition evaluation information that are input for each pipe assembling section identified by the joint number; and
a document generation processing unit configured to generate a construction management document based on the pipe connection information, the pipe laying information, and the assembled condition management information.

2. The construction management document creation device according to claim 1, wherein
the first input processing unit includes at least one of:
a list display processing unit configured to display a list of a plurality of available options for the pipe attribute information;
a code information reading processing unit configured to read code information prepared in association with the laying pipe and identify the pipe attribute information;
an image recognition processing unit configured to identify the pipe attribute information from a corresponding photograph of the laying pipe; and
a design information acquisition processing unit configured to acquire the pipe attribute information based on code information added to the pipeline design information.

3. The construction management document creation device according to claim 1, wherein
the assembled condition evaluation information includes retraction distances from a socket end of a pipe to a position of a sealing rubber gasket fitted inside the assembling section measured at a plurality of locations along a circumferential direction of the pipe with a jig, and
the second input processing unit includes an assembled condition evaluation processing unit configured to evaluate whether all of the retraction distances measured at the plurality of locations are within an allowable range and configured to display an evaluation result.

4. The construction management document creation device according to claim 1, wherein
the assembled condition evaluation information includes protrusion distances from a socket end of a pipe to a line marked around a spigot pipe measured at a plurality of locations along a circumferential direction of the pipe with a jig, and
the second input processing unit includes an assembled position evaluation processing unit configured to evaluate whether a pipe deflection angle at the assembling section is within an allowable range based on the protrusion distances measured at the plurality of locations and configured to display an evaluation result.

5. The construction management document creation device according to claim 4, wherein
the assembled position evaluation processing unit includes an allowable range setting processing unit configured to set the allowable range of the deflection angle for each joint number based on corresponding deflection angle information about pipes at each assembling section specified by the pipeline design information and configured to dynamically change the allowable range of the deflection angle for pipes at assembling sections that have not yet been input, based on a cumulative value of deflection angles of pipes at a plurality of assembling sections that have already been input.

6. The construction management document creation device according to claim 1, wherein
the first input processing unit and the second input processing unit are implemented on a portable information terminal operated by an operator at the construction site, and
the document generation processing unit is implemented on a server configured to be in communication with the portable information terminal via a communication line, the server including a database storing the pipe connection information, the pipe laying information, and the assembled condition management information transmitted from the portable information terminal.

7. A construction management document creation method executed by an information processing device configured to create a construction management document based on construction management information about pipes collected at a pipeline construction site, the method comprising:
a first input process of repeating a process of assigning a unique pipe number and a unique joint number in association with pipe attribute information, the pipe attribute information including a pipe shape and a pipe laying position that are input for each laying pipe adopted at the construction site based on pipeline design information, and thereby generating pipe connection information from which connection relationship between laying pipes is identifiable based on the pipe number and the joint number, and pipe laying information from which a type and a laying position of each laying pipe are identifiable based on the pipe attribute information;
a second input process of generating assembled condition management information based on assembling procedure confirmation information and assembled condition evaluation information that are input for each pipe assembling section identified by the joint number; and
a document generation process of generating a construction management document based on the pipe connection information, the pipe laying information, and the assembled condition management information, and storing the construction management document in a storage unit.

8. The construction management document creation method according to claim 7, wherein
the first input process includes at least one of:
a list display process of displaying a list of a plurality of available options for the pipe attribute information;
a code information reading process of reading code information prepared in association with the laying pipe and identifying the pipe attribute information;
an image recognition process of identifying the pipe attribute information from a corresponding photograph of the laying pipe; and
a design information acquisition process of acquiring the pipe attribute information based on code information added to the pipeline design information.

9. The construction management document creation method according to claim 7, wherein
the assembled condition evaluation information includes retraction distances from a socket end of a pipe to a position of a sealing rubber gasket fitted inside the assembling section measured at a plurality of locations along a circumferential direction of the pipe with a jig, and
the second input process includes an assembled condition evaluation process of evaluating whether all of the retraction distances measured at the plurality of locations are within an allowable range and displaying an evaluation result.

10. The construction management document creation method according to claim 7, wherein
the assembled condition evaluation information includes protrusion distances from a socket end of a pipe to a line marked around a spigot pipe measured at a plurality of locations along a circumferential direction of the pipe with a jig, and
the second input process includes an assembled position evaluation process of evaluating whether a pipe deflection angle at the assembling section is within an allowable range based on the protrusion distances measured at the plurality of locations and displaying an evaluation result.

11. A pipeline construction drawing creation device for creating a pipeline construction drawing based on construction management information about pipes collected at a pipeline construction site, the device comprising:
the construction management document creation device according to claim 1;
a pipeline construction drawing generation unit configured to generate a pipeline construction drawing based on the pipe connection information, the pipe laying information, and the assembled condition management information, and store the pipeline construction drawing in a storage unit, the pipeline construction drawing representing relative connection relationship between laying pipes in plan view; and
a pipeline construction drawing display processing unit configured to display the pipeline construction drawing generated by the pipeline construction drawing generation unit.

12. A pipeline construction drawing creation method for creating a pipeline construction drawing based on construction management information about pipes collected at a pipeline construction site, the method comprising:
the construction management document creation method according to claim 7;
a pipeline construction drawing generation process of generating a pipeline construction drawing based on the pipe connection information, the pipe laying information, and the assembled condition management information, and storing the pipeline construction drawing in a storage unit, the pipeline construction drawing representing relative connection relationship between laying pipes in plan view; and
a pipeline construction drawing display process of displaying the pipeline construction drawing generated by the pipeline construction drawing generation process.
